(19) United States
(12) Patent Application Publication
(10) Pub. No.: US 2012/0237169 A1
(43) Pub. Date: Sep. 20, 2012

(54) Optical Wave Guide Coupling

(75) Inventors: Marko Brammer, Hamburg (DE); Timo Mappes, Karlsruhe (DE); Marius Siegfarth, Karlsruhe (DE)

(73) Assignees: Karlsruhe Institute of Technology, Karlsruhe (DE); Buerkert Werke GmbH, Ingelfingen (DE)

(21) Appl. No.: 13/421,485

(22) Filed: Mar. 15, 2012

(30) Foreign Application Priority Data
Mar. 15, 2011 (DE) 20 2011 003 983.8

(51) Int. Cl. G02B 6/38

(52) U.S. Cl. 385/76

(57) ABSTRACT

An optical waveguide coupling part has a receiving means for an optical fiber and a coupling formation and wherein the coupling formation is hermaphroditic.

The invention relates to an optical waveguide coupling part having a receiving means for an optical fiber and a coupling formation.

### CROSS REFERENCE TO RELATED APPLICATIONS

This application claims priority to German patent application 20 2011 003 983.8 filed 15 Mar. 2011. This German application is hereby incorporated by reference as though fully set forth herein.

### BACKGROUND OF THE INVENTION

A large variety of configurations of optical waveguide couplings is known in the prior art. The main focus of the development of such optical waveguide couplings is placed on formations that allow a durable, reliable and low-loss coupling of two optical fibers.

For optical, electrical and electronic experiments it is, however, desirable to have an optical waveguide coupling at one's disposal which, with little effort, allows two optical fibers to be coupled sufficiently precisely and therefore at low loss, in particular without any complicated locking parts having to be actuated.

### BRIEF SUMMARY OF THE INVENTION

To achieve this object, according to the invention provision is made in an optical waveguide coupling part of the type mentioned at the outset that the coupling formation is hermaphroditic. The invention is based on the finding that even the use of female and male connectors impedes a quick, effortless connection of two optical fibers since it is always required to take care that a female connector and a male connector must be fitted together. If, on the other hand, a hermaphroditic coupling formation is used, either end of an optical fiber can be coupled to either end of another optical fiber which has the same type of optical waveguide coupling part provided thereon.

According to a preferred embodiment of the invention, provision is made that the coupling formation is forked. A forked coupling formation is particularly simple to manufacture and can be fitted into the forked coupling formation of a second optical waveguide coupling part with little effort.

Preferably, provision is made that the coupling formation is formed by a pair of centering arms located opposite each other. This allows a self-centering to be attained, which ensures good optical coupling and, thus, low attenuation loss.

Preferably, provision is made here that starting from an axially forwardly located tip, the centering arms widen obliquely to the rear. In this way, an automatic centering and alignment in the peripheral direction is also ensured, which greatly facilitates the assembly process.

According to one configuration of the invention, provision is made for a locking element by means of which the optical waveguide coupling part can be releasably locked to a second optical waveguide coupling part. In this way, the two optical fibers coupled with each other can be prevented from becoming inadvertently released from one another.

The locking element may more particularly contain a magnet. The magnet automatically generates a force of attraction sufficient for coupling two optical waveguide coupling parts to each other, with no mechanical locking formations having to be actuated. In addition, the optical waveguide coupling parts coupled to each other can be released from each other again by simply pulling them apart, allowing a quick and simple disassembly if required. A further advantage of the magnetic locking elements is that a magnetic coupling is relatively resistant to vibration and the magnetic forces of attraction counteract an undesirable disassembly.

According to one configuration of the invention, provision is made that the coupling formation overlaps with the locking element. This allows the coupling formation to be guided in the locking element, so that the correct alignment and coupling of the optical waveguide coupling parts to each other is improved.

According to one configuration of the invention, a seal is provided which surrounds the receiving means for the optical fiber. The space enclosed by the seal may be filled with a fluid which has the same index of refraction as the optical fibers or an index of refraction that is very close to the index of refraction of the optical fiber. This allows manufacturing tolerances and roughnesses on the surfaces of the optical fibers to be compensated and a direct optical contact to be produced between the two optical fibers. In this way, attenuation losses are minimized. The seal prevents the fluid from flowing out or vaporizing, so that the optical coupling achieved is stable over long periods of time.

In a particularly simple configuration, the seal may be formed by an O-ring. A standardized component is involved here, which is available at low cost.

In accordance with the invention, an optical waveguide coupling formed by two optical waveguide coupling parts of the type described is also provided, the two coupling formations of the optical waveguide coupling parts engaging with each other. Such an optical waveguide coupling can be manufactured with minimum effort, for example from a plastic material using an injection molding technique.

### BRIEF DESCRIPTION OF THE DRAWINGS

The invention will be described below with reference to different embodiments which are illustrated in the accompanying drawings, in which:

FIG. 1 shows a perspective view of two optical waveguide coupling parts according to the invention.

FIG. 2 shows the two coupling parts from FIG. 1 on an enlarged scale.

FIG. 3 shows a second embodiment of the optical waveguide coupling parts.

FIG. 4 shows two possible arrangements of magnets that can be used for coupling the optical waveguide coupling parts.

### DETAILED DESCRIPTION OF PREFERRED EMBODIMENTS

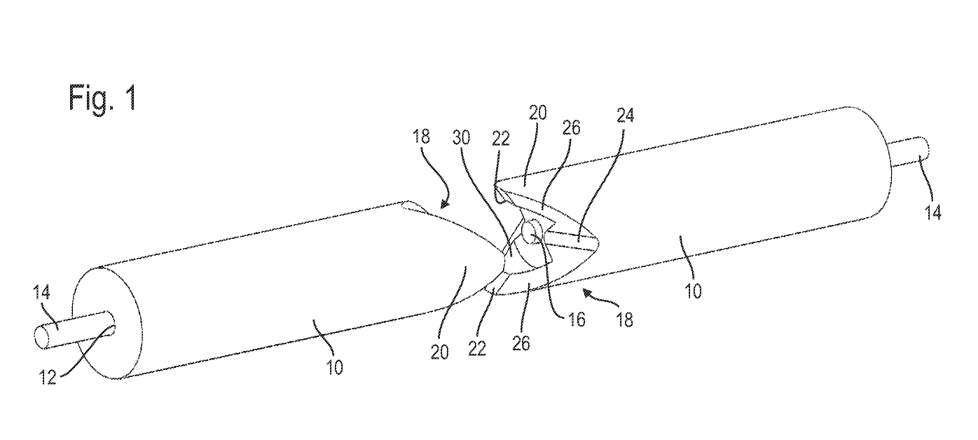

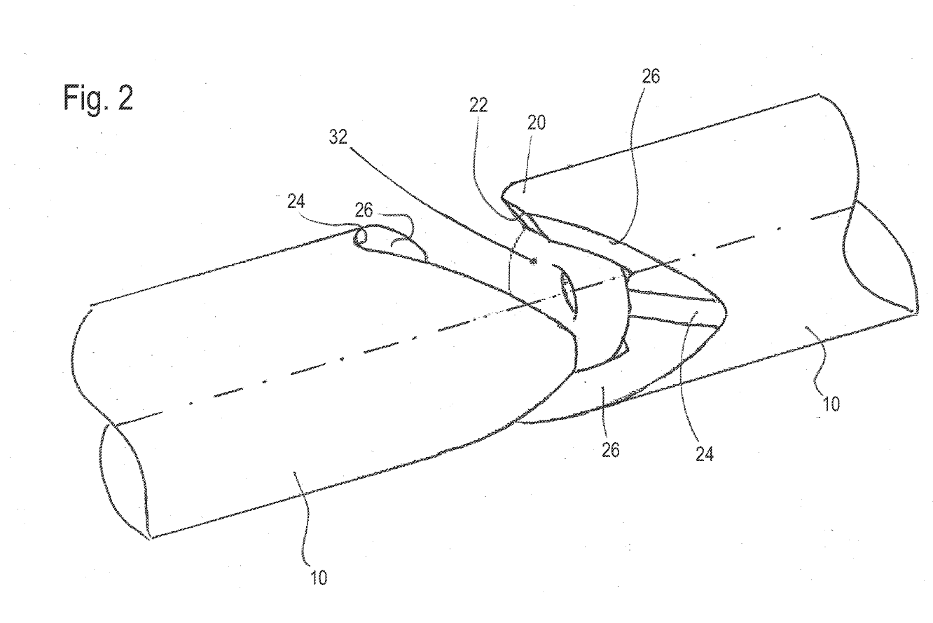

FIGS. 1 and 2 show two optical waveguide coupling parts 10 which here are in the form of oblong, cylindrical bodies having a receiving means 12 each for one respective optical fiber 14. Each receiving means 12 is formed by a borehole that extends centrically through the optical waveguide coupling part 10. The optical waveguide coupling parts 10 may be made from a plastic material or else of metal, and the optical fibers 14 may be adhesively bonded inside the receiving means 12.

Each optical waveguide coupling part 10 is provided with a coupling formation 18 at the axial end at which a front face 16 of the optical fiber 14 is also provided. Each coupling formation 18 includes a pair of centering arms 20 which are arranged opposite each other in a fork shape and widen to the rear, starting from a tip 22 that is located axially at the front. The axially “deepest” point of one centering arm 20 at the same time constitutes the transition to the second centering arm, so that a “valley” 24 is formed between the two centering arms 20.

The special feature of the coupling formations 18 resides in that they are hermaphroditic. In other words, each coupling formation 18 can be coupled to itself, in contrast to a typical plug connector, which is made up of a female connector and a male connector. When two optical waveguide coupling parts 10 are coupled to one another, the coupling formations 18 are arranged in relation to each other such that the two tips of the centering arms 20 of one coupling formation 18 engage with the valleys 24 of the coupling formation 18 of the other optical waveguide coupling part 10. In this condition, the obliquely extending side faces 26 of the centering arms 20 rest against each other, and the two front faces 16 of the optical fibers 14 contact each other, so that a good optical coupling is achieved with low loss.

For the automatic centering, provision is made that the side faces 26 of the centering arms 20 are planar and have a slope of 45 degrees, allowing identically formed coupling arms of two optical waveguide coupling parts 10 to be fitted into one another. This results in a substantially gap-free transition from one optical waveguide coupling part to the neighboring optical waveguide coupling part. But other slopes can also be used for the side faces. If a greater angle of slope is used, a larger overlap of the coupling parts is obtained and thus a greater resistance to tilting. In that case, however, the manufacturing process is more difficult. Using a smaller angle of slope, on the other hand, makes manufacturing simpler, but the resistance to tilting decreases. For this reason, a mean value is selected for the angle of slope in order to obtain a trade-off between good manufacturability and high resistance to tilting.

A generally cylindrical receiving space 30 for a seal 32, which is shown in FIG. 2, is provided around the optical fibers 14 within the centering arms 20. The seal 32 is arranged within the receiving space 30 such that it leaves a space in the center for the optical fibers 14 to pass through. The seal 32 may be formed as an O-ring from an elastically flexible plastic material or rubber and, in practice, may be filled with a fluid, in particular a gel having an index of refraction that is as close as possible to the index of refraction of the fibers. In this way, very good optical coupling between the two optical fibers is achieved, despite any possible manufacturing tolerances and surface roughnesses on the front faces 16 of the optical fibers 14. The use of an appropriate gel also allows the effort of polishing the front faces 16 of the optical fibers 14 to be reduced, without the quality of the optical coupling being noticeably reduced thereby. With the optical waveguide coupling parts 10 coupled to each other, the seal 32 ensures that the gel does not flow out of the coupling or can dry out.

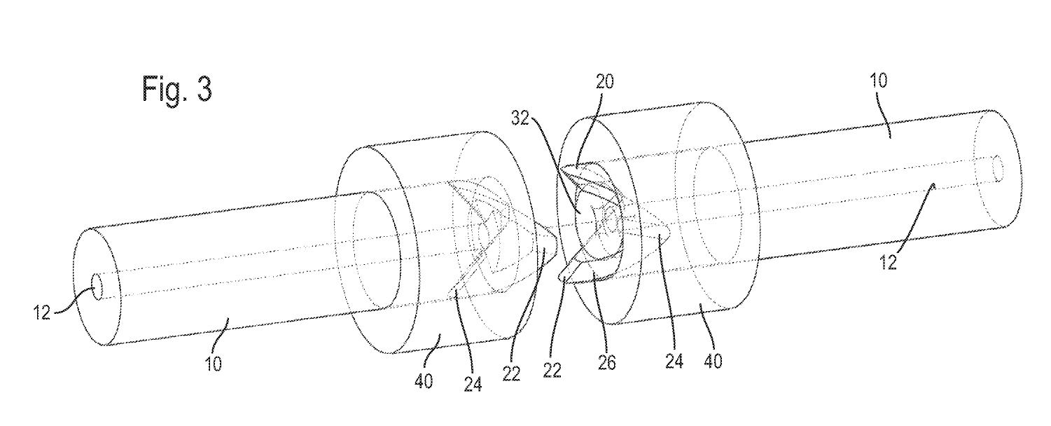

FIG. 3 shows an embodiment in which the optical waveguide coupling parts 10 known from FIGS. 1 and 2 are used. Each optical waveguide coupling part has a locking element 40 provided thereon which here is in the form of a ring arranged on that end of the optical waveguide coupling part 10 that is provided with the coupling formation 18. In this case, the locking elements each contain magnets (not illustrated), so that they mutually attract each other. Owing to the magnetic forces of attraction, two optical waveguide coupling parts 10 can be reliably coupled to each other without any external mechanical locking means needing to be actuated or released from each other again for separating the optical coupling. It is sufficient to pull the two optical waveguide coupling parts 10 apart, contrary to the magnetic force of attraction. It is of particular advantage if the two locking elements 40 are arranged in such a way that their front faces are located roughly at the middle between the valley 24 and the tip 22 of each coupling formation. This arrangement results in that for plugging the coupling, the tips 22 of the centering arms 20 of one optical waveguide coupling part 10 need to be inserted into the interior of the locking element 40 of the other optical waveguide coupling part 10 and are therefore guided within the cylindrical inner wall of the respective locking element 40. This increases the axial centering and guiding effect when the coupling formations 18 are inserted into each other.

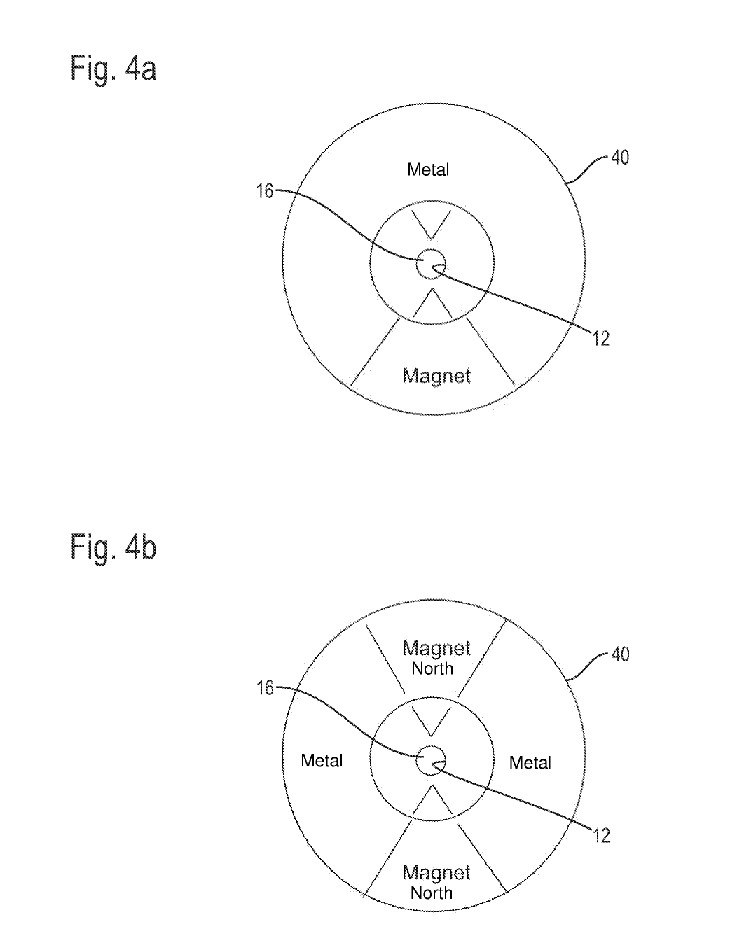

FIGS. 4a and 4b illustrate two examples of the arrangement of magnets in the locking elements 40. To avoid the problems that arise when using two permanent magnet rings, use is made of a ring made of a magnetizable metal having a permanently magnetic portion (see FIG. 4a) or having two permanently magnetic portions (see FIG. 4b). This enables the two optical waveguide coupling parts to be coupled with each other in any orientation.

What is claimed is:

1. An optical waveguide coupling part comprising a receiving means for an optical fiber and a coupling formation, wherein the coupling formation is hermaphroditic.

2. The optical waveguide coupling part according to claim 1, wherein the coupling formation is forked.

3. The optical waveguide coupling part according to claim 1, wherein the coupling formation is formed by a pair of centering arms located opposite each other.

4. The optical waveguide coupling part according to claim 3, wherein starting from an axially forwardly located tip, the centering arms widen obliquely to the rear.

5. The optical waveguide coupling part according to claim 1, wherein a locking element is provided by means of which the optical waveguide coupling part can be releasably locked to a second optical waveguide coupling part.

6. The optical waveguide coupling part according to claim 5, wherein the locking element contains a magnet.

7. The optical waveguide coupling part according to claim 5, wherein the coupling formation overlaps with the locking element.

8. The optical waveguide coupling part according to claim 1, wherein a seal is provided which surrounds the receiving means.

9. The optical waveguide coupling part according to claim 8, wherein the seal is formed by an O-ring.

10. An optical waveguide coupling formed by two optical waveguide coupling parts according to claim 1, in which the coupling formations of the two optical waveguide coupling parts engage with each other.
